(19) United States
(12) Patent Application Publication
(10) Pub. No.: US 2004/0142198 A1
(43) Pub. Date: Jul. 22, 2004

(54) Magnetostrictive/magnetic material for use in torque sensors

(76) Inventor: Thomas Hubert Van Steenkiste, Ray, MI (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/348,151

(22) Filed: Jan. 21, 2003

(51) Int. Cl. B05D 5/12; B05D 1/02; B32B 15/16

(52) U.S. Cl. 428/553; 427/421; 427/128; 427/598; 428/900; 428/928; 428/937; 148/300

(57) ABSTRACT

A kinetically sprayed magnetostrictive/magnetic material, comprising: magnetostriction particles; magnetic particles with coercivity; a ductile matrix for bonding the magnetostriction particles and magnetic particles with coercivity together; wherein an applied magnetic field will align the magnetic particles with coercivity and subsequently the magnetostriction particles such that the magnetostrictive material will produce a detectable change in the magnetostrictive/magnetic material when placed under an applied stress. A method of forming a composite coating of magnetostrictive/magnetic material on a substrate, comprising: spraying a powder mixture of magnetostriction particles, magnetic particles with coercivity and a ductile matrix in a spray gas stream flowing at supersonic velocity against the substrate to form a composite coating wherein an applied magnetic field will align the magnetic particles with coercivity and subsequently the magnetostriction particles such that the magnetostrictive material will produce a detectable change in the magnetostrictive/magnetic material when placed under an applied stress.

### TECHNICAL FIELD

This disclosure relates to torque sensing apparatus and, in particular, a method of preparing a magnetostrictive/magnetic coating on a substrate wherein the coating comprises magnetostrictive particles with magnetic particles for sensing the torque applied to a rotating shaft.

### BACKGROUND

In systems having rotating drive shafts it is sometimes necessary to know the torque and speed of these shafts in order to control the same or other devices associated with the rotatable shafts. Accordingly, it is desirable to sense and measure the torque applied to these items in an accurate, reliable and Inexpensive manner.

Sensors to measure the torque imposed on rotating shafts, such as but not limited to shafts in vehicles, are used in many applications. For example, it might be desirable to measure the torque on rotating shafts in a vehicle's transmission, or in a vehicle's engine (e.g., the crankshaft), or in a vehicle's automatic braking system (ABS) for a variety of purposes known in the art.

One application of this type of torque measurement is in electric power steering systems wherein an electric motor is driven in response to the operation and/or manipulation of a vehicle steering wheel. The system then interprets the amount of torque or rotation applied to the steering wheel and its attached shaft in order to translate the information into an appropriate command for all operating means of the steerable wheels of the vehicle.

Prior methods for obtaining torque measurement in such systems was accomplished through the use of contact-type sensors directly attached to the shaft being rotated. For example, one such type of sensor is a “strain gauge” type torque detection apparatus, in which one or more strain gauges are directly attached to the outer peripheral surface of the shaft and the applied torque is measured by detecting a change in resistance, which is caused by applied strain and is measured by a bridge circuit or other well-known means.

Another type of sensor used is a non-contact torque sensor wherein magnetostrictive materials are disposed on rotating shafts and sensors are positioned to detect the presence of an external flux which is the result of a torque being applied to the magnetostrictive material.

Such magnetostrictive materials are typically produced or provided by either pre-stressing the magnetostrictive material by using, applied forces (e.g., compressive or tensile) to pre-stress the coating prior to magnetization of the pre-stressed coating in order to provide the desired magnetic field. Alternatively, an external magnet or magnets are provided to produce the same or a similar result to the magnetostrictive material.

To this end, magnetostrictive torque sensors have been provided wherein a sensor is positioned in a surrounding relationship with a rotating shaft, with an air gap being established between the sensor and shaft to allow the shaft to rotate without rubbing against the sensor. A magnetic field is generated in the sensor by passing electric current through an excitation coil of the sensor. This magnetic field permeates the shaft and returns back to a pick-up coil of the sensor.

The output of the pick-up coil is an electrical signal that depends on the total magnetic reluctance in the above-described loop. Part of the total magnetic reluctance is established by the air gap, and part is established by the shaft itself, with the magnetic reluctance of the shaft changing as a function of torque on the shaft. Thus, changes in the output of the pick-up coil can be correlated to the torque experienced by the shaft.

As understood herein, the air gap, heretofore necessary to permit relative motion between the shaft and sensor, nonetheless undesirably reduces the sensitivity of conventional magnetostrictive torque sensors. As further understood herein, it is possible to change the air gap between a shaft and a magnetostrictive torque sensor, thereby increasing the sensitivity of the sensor vis-a-vis conventional sensors. Moreover, the present disclosure recognizes that a phenomenon known in the art as “shaft run-out” can adversely effect conventional magnetostrictive torque sensors, and that a system can be provided that is relatively immune to the effects of shaft run-out.

### SUMMARY

A kinetically sprayed magnetostrictive/magnetic material, comprising: magnetostriction particles; magnetic particles with coercivity; a ductile matrix for bonding the magnetostriction particles and magnetic particles with coercivity together; wherein an applied magnetic field will align the magnetic particles with coercivity and subsequently the magnetostrictive particles such that the magnetostrictive/magnetic material will produce a detectable change in the magnetostrictive material when placed under an applied stress.

A method of forming a composite coating of magnetostrictive/magnetic material on a substrate, comprising: spraying a powder mixture of magnetostriction particles, magnetic particles with coercivity and a ductile matrix in a spray gas stream flowing at supersonic velocity against the substrate to form a composite coating wherein an applied magnetic field will align the magnetic particles with coercivity and subsequently the magnetostriction particles such that the magnetostrictive/magnetic material will produce a detectable change in the magnetostrictive material when placed under an applied stress.

The present disclosure relates to a high velocity, kinetic energy spray process for applying a particulate mixture of magnetostrictive compound and magnetic particles with coercivity material on a substrate as a magnetostrictive/magnetic composite. The subject method is particularly useful for forming such coatings on round shafts, such as automotive steering columns, to serve in a torque sensing system.

This disclosure provides a method of forming a magnetostrictive/magnetic composite coating on a desired substrate. In accordance with an exemplary embodiment of the present disclosure, the coating is applied to a suitable steel or aluminum automobile steering shaft to serve as a portion of a torque sensor device for determining angular position of the shaft in an electronically controlled power steering system.

A mixture of magnetostriction particles and magnetic particles with coercivity in a powder form are sprayed onto a suitable substrate by a relatively low temperature supersonic velocity spray process sometimes called kinetic spraying. Kinetic spray processes are described in the following U.S. Pat. Nos. 6,645,039; 6,139,913; and 5,302,414. The powder mixture is transported from a powder reservoir in a relatively low volume, high pressure stream of unheated gas and introduced into a larger volume, high pressure gas stream of heated carrier spray gas. The combined stream of gas undergoes adiabatic expansion through a suitable converging-diverging nozzle, such as a de Laval nozzle. During passage through the converging-diverging nozzle the stream achieves a very high velocity, a supersonic velocity, with particles accelerating due to drag effects with the high velocity gas. The carrier spray gas is heated to increase its velocity in the nozzle. These high kinetic energy particles are directed against a desired substrate such as a steering column. The spray nozzle is moved in a suitable pattern over or around the substrate to accumulate a coating pattern of desired thickness. The substrate is not normally preheated but it may experience some temperature increase from the high energy impact of the sprayed particles and gas stream.

As the high velocity particles impact the substrate they plastically deform and form a well-adhered composite coating. The character and chemical identity of the individual components of the coating are unchanged but they are bonded together in a mechanically formed matrix of a suitable composition to provide magnetostrictive/magnetic properties to the coating.

Thus, for example, a circumferential annular band of the composite material can be formed on a steering shaft and then magnetized circumferentially for use in a magnetostrictive torque sensor.

### DESCRIIION OF THE FIGURES

FIG. 1 is a general schematic layout of a kinetic spray system for applying the magnetostrictive/magnetic material of the present disclosure;

FIG. 2 is an enlarged cross-sectional view of a kinetic spray nozzle used in the system of FIG. 1 for mixing spray powder with heated high pressure air and accelerating the mixture to supersonic speeds for impingement upon the surface of a substrate to be coated;

FIG. 3 is a view illustrating a magnetostrictive/magnetic material applied to a shaft;

FIG. 4 is a view along lines 4-4 of FIG. 3;

FIG. 5 is an enlarged portion of FIG. 4;

FIGS. 6 and 7 are graphs illustrating the torque response as a function of an applied torque for a magnetostrictive/magnetic coating of approximately 33 percent ALNiCo₅, 33 percent nickel and 33 percent iron;

FIG. 8 is a graph illustrating the torque response of a kinetically sprayed magnetostrictive/magnetic composite coating of approximately 33 percent ALNiCo₅, 33 percent nickel and 33 percent copper disposed on a nitronic steel shaft;

FIG. 9 is a graph illustrating the torque response of a kinetically sprayed magnetostrictive/magnetic composite coating of approximately 33 percent ALNiCo₅, 33 percent nickel and 33 percent iron disposed on a nitronic steel shaft;

FIG. 10 is a graph illustrating the signal response to applied torque as a function of percent nickel (Ni) in the initial starting powders of the kinetic spray application process;

FIGS. 11-13 are various graphs illustrating the signal response to applied torque for magnetostrictive/magnetic composites of varying compositions;

FIGS. 14 and 15 are photomicrographs of a magnetostrictive/magnetic composite of approximately 10 percent ALNiCo₅, 80 percent nickel and 10 percent iron under 200× magnification and 1000× magnification respectively;

FIG. 16 is a graph illustrating the torque signal response of a kinetically sprayed magnetostrictive/magnetic composite coating of approximately 10 percent ALNiCo₅, 80 percent nickel and 10 percent iron disposed on a 1020 steel shaft; and

FIG. 17 is a graph illustrating the torque signal response of a function of applied torque for a kinetically sprayed composite coating of approximately 10 percent ALNiCo₅, 80 percent nickel and 10 percent iron disposed on a 6061-T6 Aluminum shaft.

### DETAILED DESCRIPTION

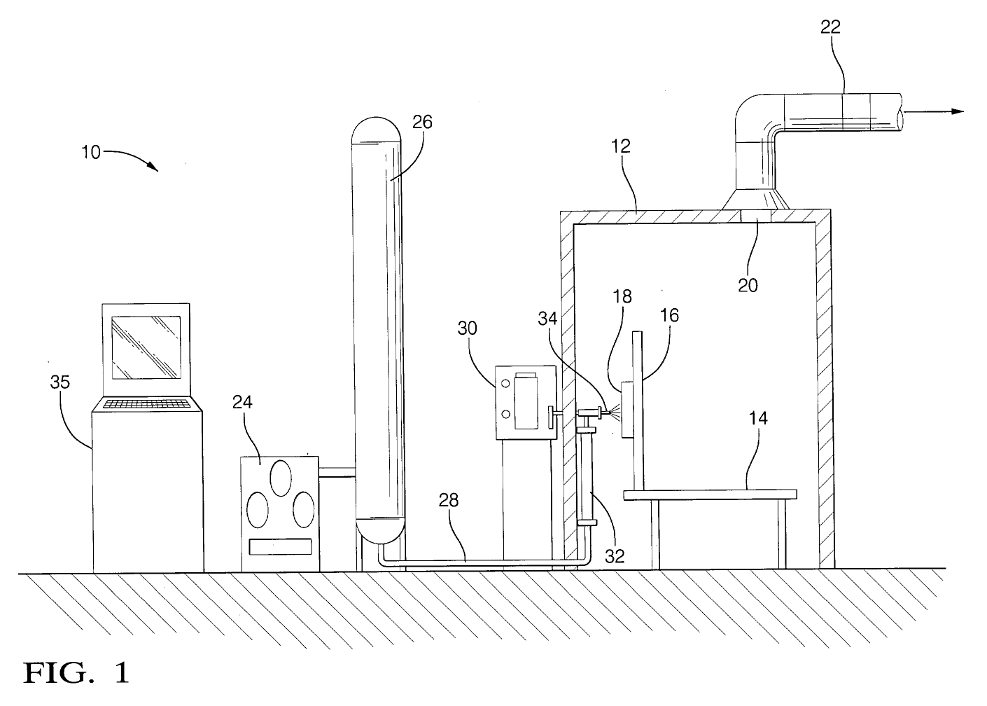

Referring now to FIG. 1, numeral 10 generally indicates a kinetic spray system for use in applying the magnetostrictive/magnetic material of the present disclosure. System 10 is illustrated and disclosed in U.S. Pat. Nos. 6,139,913 and 6,645,039 the contents of which are incorporated herein by reference thereto. FIGS. 1 and 2 of this specification are like the corresponding figures of the '913 and the '039 patent for the purpose of illustrating the kinetic spray process.

Of course, it is contemplated that other systems may be used to apply the magnetostrictive/magnetic material of the present disclosure. For example, some of the other types of spray applications are discussed and disclosed in U.S. Pat. No. 6,189,663 the contents of which are also incorporated herein by reference thereto as well as the processes discussed in the cited art of the '913, '039 and '663 patents. Moreover, the application process of the present disclosure is not intended to be limited by specific examples provided in the aforementioned patents, for example specific particle sizes used in the abovementioned processes.

In an exemplary embodiment, the magnetostrictive/magnetic material of the present disclosure is applied by a kinetic spray process. Kinetic spray processes involve entraining suitable coating particles in a gaseous stream and propelling the particles at supersonic speed against a substrate to be coated. The gas may be heated to increase its velocity but not to soften or melt the particles. The ductile particles are plastically deformed and bonded on the substrate where they adhere without phase or composition change. Sealing may also be required for kinetic spray applied metallic coatings.

System 10 includes an enclosure 12 in which a support table 14 or other support means is located. A mounting panel 16 fixed to the table 14 supports a work holder 18 capable of movement in three dimensions and able to support a suitable workpiece formed of a substrate material to be coated. The enclosure 12 includes surrounding walls having at least one air inlet, not shown, and an air outlet 20 connected by a suitable exhaust conduit 22 to a dust collector, not shown. During coating operations, the dust collector continually draws air from the enclosure and collects any dust or particles contained in the exhaust air for subsequent disposal or recycling.

The spray system further includes an air compressor 24 capable of supplying air pressure up to 3.4 MPa (500 psi) to a high pressure air ballast tank 26. The air tank 26 is connected through a line 28 to both a high pressure powder feeder 30 and a separate air heater 32. The air heater 32 supplies high pressure heated air to a kinetic spray nozzle 34. The powder feeder mixes particles of powder with unheated high pressure air and supplies the mixture to a supplemental inlet of the kinetic spray nozzle 34. A computer control 35 operates to control the pressure of gas supplied to the nozzle 34 and powder feeder 30 and the temperature of high pressure air supplied to the spray nozzle 34.

Referring now to FIG. 2 the kinetic spray nozzle 34 and its connection to the air heater 32 via a main air passage 36 are schematically illustrated. Passage 36 connects with a premix chamber 38, which directs air through a flow straightener 40 into a mixing chamber 42. Temperature and pressure of the air or other gas are monitored by a gas inlet temperature thermocouple 44 connected with the main air passage 36 and a pressure sensor 46 connected with the mixing chamber 42.

The mixture of unheated high pressure air and coating powder is fed through a supplemental inlet line 48 to a powder feeder injection tube 50 which comprises a straight pipe having a predetermined inner diameter.

The pipe 50 has an axis 52, which is preferably also the axis of the premix chamber 38. The injection tube extends from an outer end of the premix chamber along its axis and through the flow straightener 40 into the mixing chamber 42.

Mixing chamber 42, in turn, communicates with a de Laval type nozzle 54 that includes an entrance cone 56 with a diameter which decreases from 7.5 mm to a throat 58 having a diameter of 2.8 mm. Downstream of the throat 58, the nozzle has a rectangular cross section increasing to 5 mm by 12.5 mm at the exit end 60.

The spraying operation involves directing the spray nozzle toward a substrate so that a suitable proportion of the sprayed particles strike the substrate and adhere to it. The outlet of the spray nozzle may be shaped to produce a spray pattern that complements the shape of the substrate. The nozzle, the substrate or both may be moved during the spray operation to obtain the composite coating. The proportions of the magnetostrictive particles and magnetic particles with coercivity in the spray mixture may be adjusted, if necessary, to achieve a specified composition in the composite coating. In addition, if either the magnetostrictive particles or the magnetic particles with coercivity are not ductile, a ductile matrix is added to the spray mixture.

The practice of this spray process provides the following features: a coating of magnetostrictive particles, magnetic particles with coercivity and if necessary, a ductile matrix is successfully deposited by the kinetic spraying process; a mechanically deposited coating that includes magnetic particles with coercivity which negate the need for pre-stressing the composite; a magnetostrictive/magnetic composite coating; and the capability to apply the coating on a suitable shaft such that an applied torque can be sensed.

As discussed above, prior applications of magnetostrictive materials required the use of either an external magnet or pre-stressing of the magnetostrictive materials in order to align the materials moments in the magnetization process in order to provide the magnetostrictive/magnetic material with the desired magnetic properties namely, a material which when subjected to an applied torque causes a magnetic flux or torque flux to leave the magnetostrictive/magnetic material. This flux is the torque signal that will be picked up by devices configured to receive and interpret such a signal. However, and in accordance with the present disclosure a magnetostrictive/magnetic material comprising an internal magnetic field is capable of being formed through the use of a kinetic spray process. This material does not require pre-stressing as it is applied in a manner that allows the materials to be magnetically aligned. This is primarily accomplished by including a magnetic particles with coercivity such as AlNiCo₅ magnets, magnequench or melt spun terfenol in the powder that is used in kinetic spray application process. Theses materials will act like little magnets disposed throughout the entire composite in order to assist with the aligning of the low coercivity magnetostrictive materials. Thus, this magnetostrictive/magnetic composite will have an internal magnetic field that keeps everything aligned, once it is magnetized in a circumferential direction. The magnetic particles will align the magnetostrictive particles in order to provide a composite with the desired performance. Each of the magnets in the composite will serve to align the flux lines between the magnetostrictive particles of the composite material.

As described in the prior patents mentioned with regard to kinetic spray applications, there is considerable latitude in the size of particles that can be sprayed. In an exemplary embodiment the particles size is greater than 50 microns with a preferred range approximately 63-106 microns. Of course, it is contemplated that the size of the particles can be greater or lesser than aforementioned sizes and described range.

The powder mixtures were prepared and placed in the powder spray reservoir. An example of the powder feed gas used to transport the powder mixture from the reservoir is nitrogen. The nitrogen was unheated. The powder is introduced into the feed gas stream using a feed screw and the “feed rate” of the powder into the carrier gas stream was varied by changing the rotation rate of the screw. The nitrogen borne powder is carried to the spray gun for mixing with a larger volume of main spray gas, which may be pre-heated before the mixed stream enters the spray nozzle. The pressure of the main gas and temperature will vary depending on what type of gas is being used (e.g., air or helium).

The nozzle and related apparatus can be adapted to spray the mixture onto a flat surface or a rotating shaft wherein movement of the nozzle and rotation of the shaft, if applicable, is varied to provide desired thickness. Accordingly, the number of passes and rate of application may vary.

It is apparent that the mixture being sprayed contains particles of different physical characteristics that may affect their tendency to adhere to a substrate. Moreover, the relative shapes of the spray pattern and the substrate can affect the yield of sprayed particles that adhere to the substrate. Depending upon actual experience with a specific metal particle mixture and substrate shape it may be necessary to adjust the proportions of the constituents to achieve a specified magnetostrictive/magnetic composite composition.

The kinetic spray process used in the practice of this disclosure provides a relatively simple way to form magnetostrictive/magnetic composite coatings on a substrate that does not require hot pressing to consolidate the composite. By using multiple passes of the kinetic spray gun, coatings of several mm in thickness can be built up.

Several magnetostrictive materials have low coercivity properties. In accordance with an exemplary embodiment of the present disclosure magnetostrictive materials are mixed with high coercivity materials, which would magnetize the low coercivity magnetostrictive materials in one preferred direction. In a sense these magnetostrictive materials would be in a permanent magnetic field. The moments of these magnetostrictive materials would stay aligned with the flux from the high coercivity material. Applying a torque on this composite coating would rotate the magnetostrictive material's flux away from the aligned magnetic field and could be measured using a magnetometer.

An example of the composite for use in such a torque sensing device would comprise ingot Terfenol, iron, iron alloys, ingot rare earth composites (low coercivity high magnetostrictive material) mixed with a high coercivity material (AlNiCo₅ magnets, magnequench or melt spun terfenol). This magnetostrictive/magnetic composite material is mixed and incorporated into a metal matrix by an application process such as kinetic spraying described above or magnetic dynamic compaction, etc. The coating is then magnetized in the preferred direction (e.g., circumferentially on a shaft) and accordingly, an applied torque to the shaft will cause the flux to rotate out of the aligned direction and therefore can be measured. When no torque is being applied the flux within the magnetostrictive material will follow the high coercivity field. Accordingly, this material is capable of being used to detect torque on a shaft.

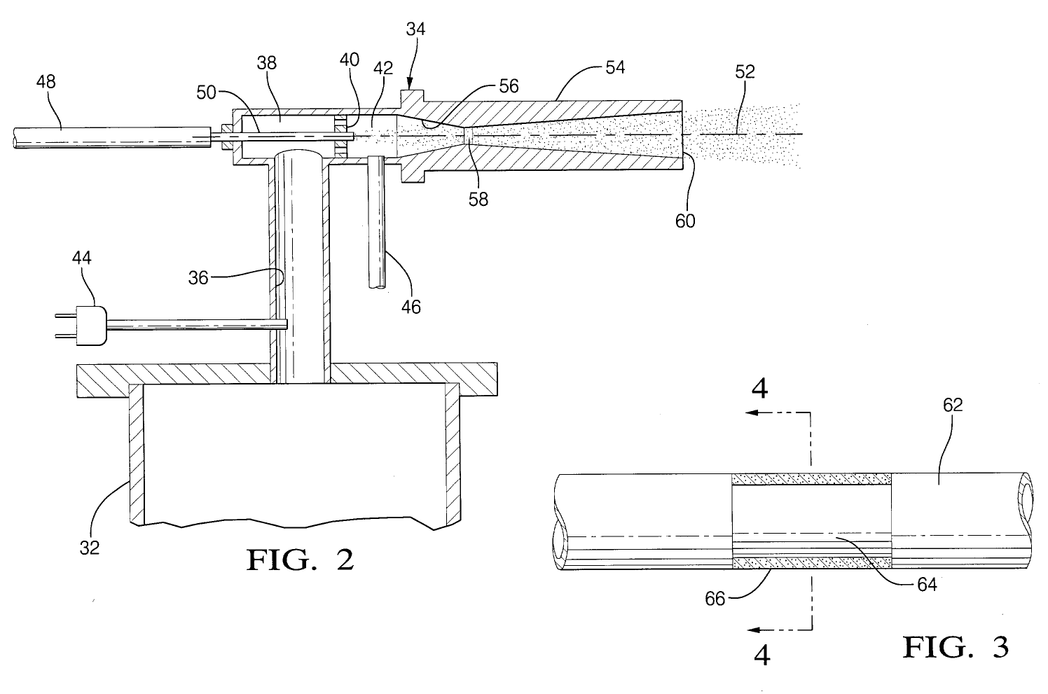

FIG. 3 is a drawing of shaft 62 with its integral coating deposited magnetostrictive/magnetic coating by kinetic spraying. Shaft 62 is formed, for example, of nitronic steel and was machined over its length to reduce its radius by to provide a recess 64 to receive the spray coating of magnetostrictive/magnetic material 66. Alternatively, the shaft is provided with collars which define the recess area and are removed after the kinetic spray application process. In this alternative the magnetostrictive/magnetic material will protrude from the surface of the shaft. In an exemplary embodiment the shaft is formed of a material that will not adversely affect the flux signal generated by the magnetostrictive/magnetic material.

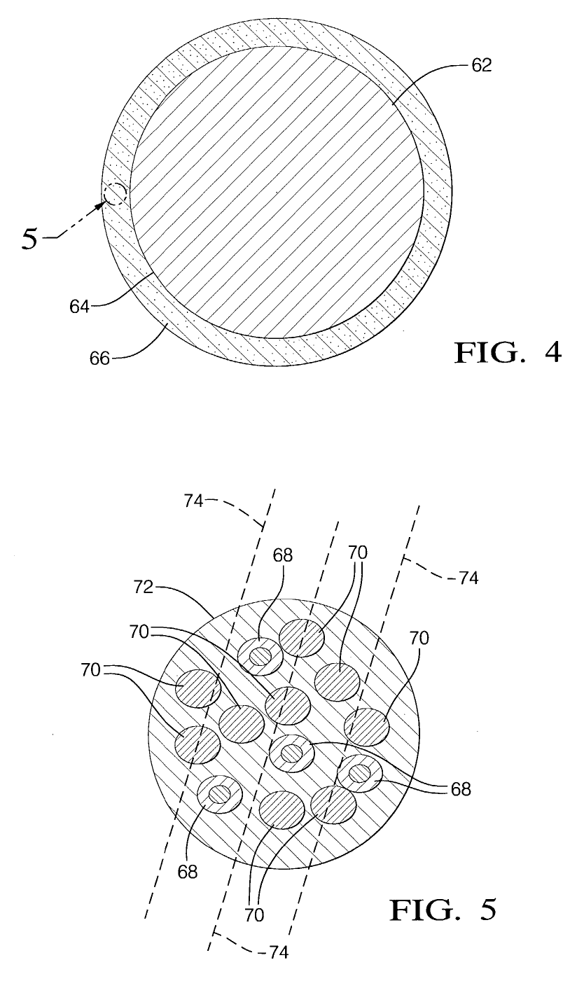

Referring now to FIG. 4, a cross-sectional view of shaft 62 having a magnetostrictive/magnetic material 66 deposited thereon is illustrated. In an exemplary embodiment shaft 62 is a non-magnetically permeable material, such as a Nitronic shaft, stainless steel or aluminum. Here magnetostrictive/magnetic material 66 is applied to shaft 62 using the apparatus and methods of FIGS. 1 and 2 as well as U.S. Pat. Nos. 6,139,913 and 6,465,039.

FIG. 5 is an enlarged view of magnetostrictive/magnetic coating 66. The coating comprises high magnetostriction particles 68, high coercivity magnetic particles 70 and a ductile matrix 72. The high magnetostriction particles 68 have low coercivity properties and the ductile matrix holds the materials together. The ductile matrix 72 is not required if either the high magnetostriction particles 68 or the high coercivity magnetic particles 70 are ductile enough to bond the two together.

The high coercivity magnetic particles 68 also have a magnetic moment illustrated by lines 74. Magnetization of the magnetic particles with coercivity provides for an internal magnetic aligning of the magnetostriction component without the need for any applied stress, which if required adds to the cost of the material and/or the device it is applied to. In addition, if applied stress is used this may adversely affect the material by making it susceptible to cracking, creep or thermal cycling. Thus, the high coercivity material dispersed through the coating (once magnetized circumferentially) acts as internal bias magnets aligning the moments of the magnetostriction material.

As discussed above an example of the magnetostriction particles 68 would be ingot Terfenol, iron, iron alloys, ingot rare earth composites, nickel and equivalents thereof (low coercivity high magnetostrictive material) and an example of the high coercivity magnetic particles 70 would be AlNiCo₅ magnets, magnequench or melt spun terfenol and equivalents thereof and, if necessary, an example of the ductile matrix material would be nickel, copper, aluminum and equivalents thereof as well as the materials described in U.S. Pat. No. 6,465,039.

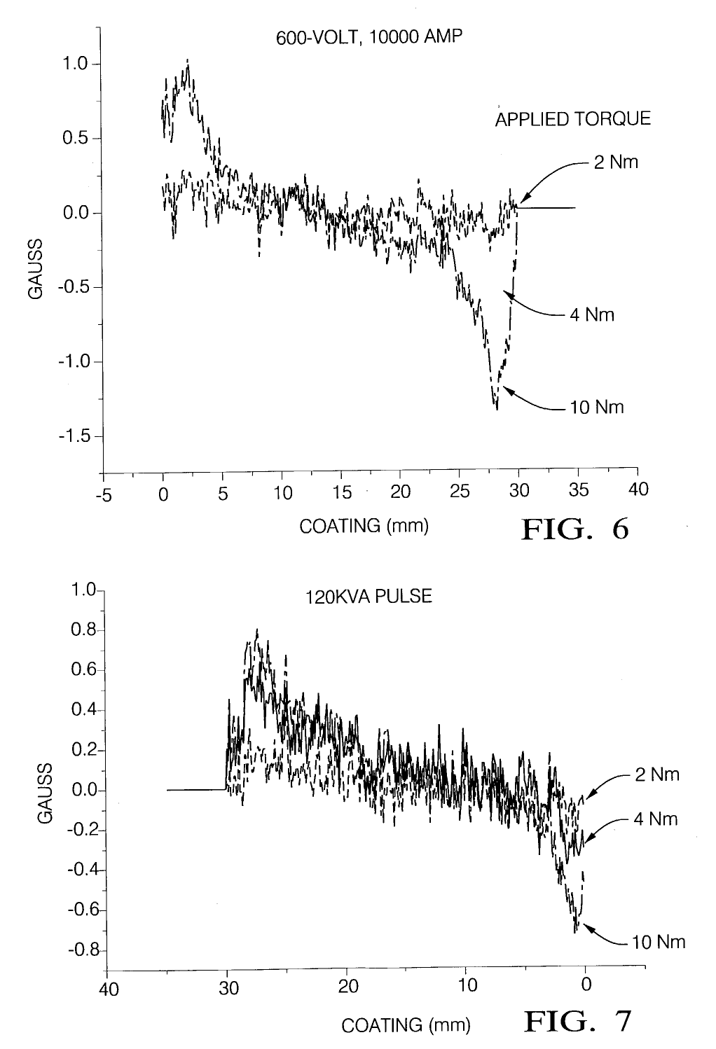

Tests of coated shafts of varying magnetostrictive/magnetic material compositions were preformed in a torque sensor configuration and are shown in FIGS. 6-13, 16 and 17 The coating of the magnetostrictive material of the present disclosure was first circumferentially magnetized by external permanent magnets or by passing a large current pulse through a copper rod inserted along the axis of the shaft. A known torque was applied to the shaft and a secondary Hall sensor located a distance from the coating measured changes in the radial magnetic field generated by the coating in response to the torque.

FIG. 6 is a graph illustrating the torque response as a function of an applied torque of 2 Newton meters, 4 Newton meters and 10 Newton meters after pulsing using a 600Volt, 10000Amp current pulse from a Magnetic Instrumentation Pulser. FIG. 7 is a graph illustrating the torque response as a function of an applied torque of 2 Newton meters, 4 Newton meters and 10 Newton meters on the same coating shown in FIG. 6 after 120 KVA pulsing using an IAP pulser. FIGS. 6 and 7 illustrate that little difference is observed in the torque response between the high current pulse and the lower current pulse. As illustrated the lower current is sufficient to magnetize the coating. This allows for lower current pulsing to magnetize the coating, which translates into cost and operation saving, such as lower capital investment, and operating costs. The magnetostrictive/magnetic material tested in FIGS. 6 and 7 consisted of approximately 33 percent ALNiCo₅, 33 percent nickel and 33 percent iron disposed on a nitronic steel shaft in accordance with a kinetic spray application process. It is, of course, contemplated that the percentages of the materials comprising the magnetostrictive/magnetic material may vary to be greater or less than those previously mentioned with regard to FIGS. 6 and 7.

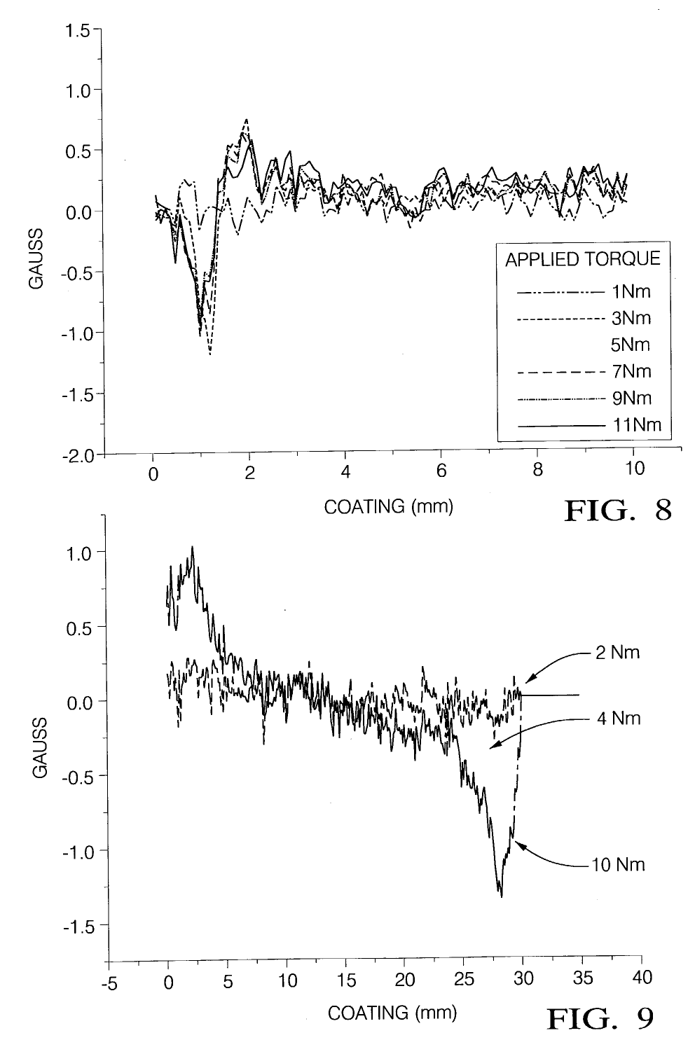

FIG. 8 is a graph illustrating the torque response as a function of applied torque of a kinetically sprayed magnetostrictive/magnetic composite coating of approximately 33 percent ALNiCo₅, 33 percent nickel and 33 percent copper disposed on a nitronic steel shaft. The measured applied torques were 1 Newton meters, 3 Newton meters, 5 Newton meters, 7 Newton meters, 9 Newton meters and 11 Newton meters. It is, of course, contemplated that the percentages of the materials comprising the magnetostrictive/magnetic material may vary to be greater or less than those previously mentioned with regard to FIG. 8. FIG. 8 shows that the signal is much noisier than if the copper is replaced by iron.

FIG. 9 is a graph illustrating the torque response as a function of applied torque of a kinetically sprayed magnetostrictive/magnetic composite coating of approximately 33 percent ALNiCo₅, 33 percent nickel and 33 percent iron disposed on a nitronic steel shaft. The measured applied torques were 2 Newton meters, 4 Newton meters and 10 Newton meters. As illustrated, the magnetic signal response increases as a function of shaft torque. It is, of course, contemplated that the percentages of the materials comprising the magnetostrictive/magnetic material may vary to be greater or less than those previously mentioned with regard to FIG. 9. In this composition the iron improves the signal response with regard to applied torque.

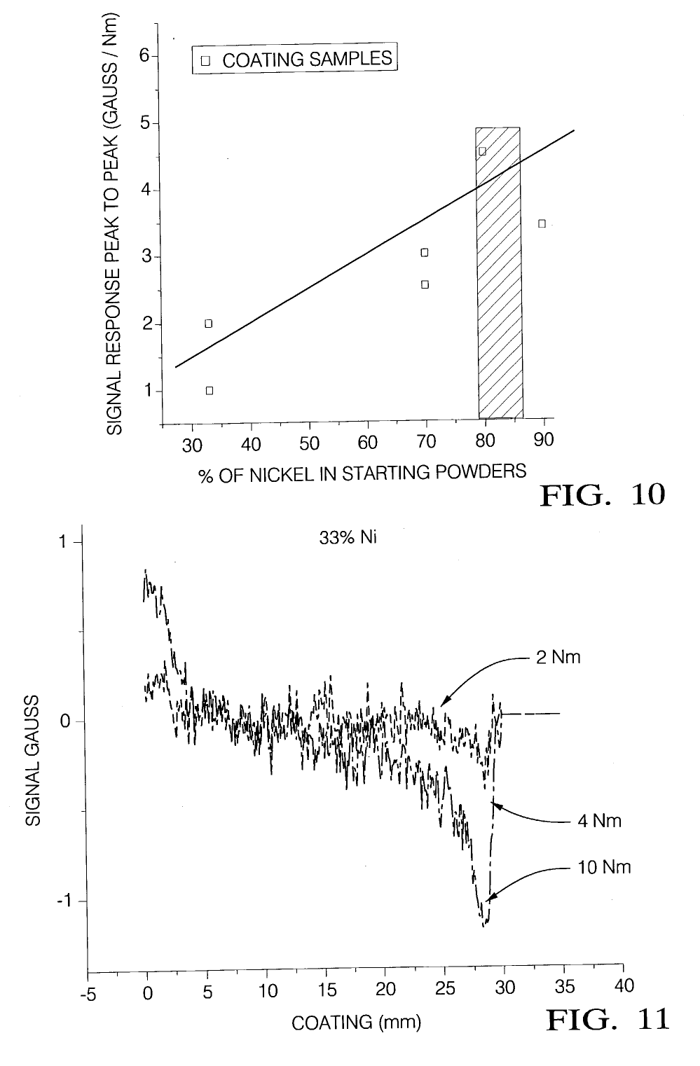

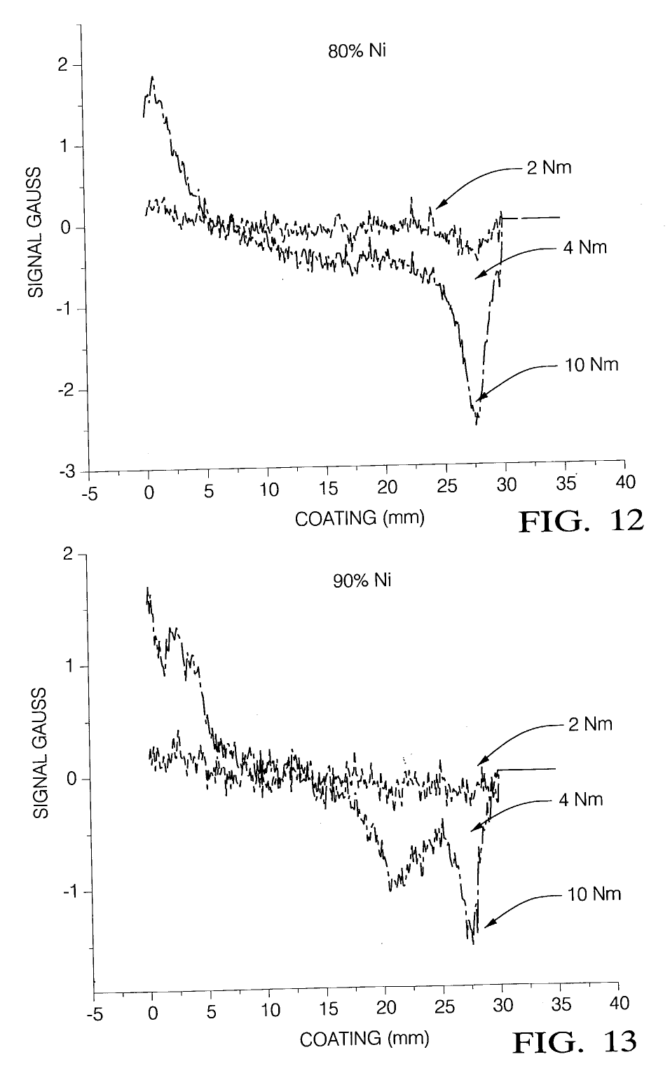

FIG. 10 is graph illustrating the signal response to applied torque as a function of percent nickel (Ni) in the initial starting powders of the kinetic spray application process. FIGS. 11-13 are various graphs illustrating the signal response to applied torque for magnetostrictive/magnetic composites of varying compositions. For example, FIG. 11 is graph illustrating the signal response to applied torque for magnetostrictive/magnetic composite of approximately 33 percent ALNiCo₅, 33 percent nickel and 33 percent iron. FIG. 12 is graph illustrating the signal response to applied torque for magnetostrictive/magnetic composite of approximately 10 percent ALNiCo₅, 80 percent nickel and 10 percent iron. FIG. 13 is graph illustrating the signal response to applied torque for a magnetostrictive/magnetic composite of approximately 10 percent ALNiCo₅, and 90 percent nickel. The measured applied torque in each of the graphs is 2 Newton meters, 4 Newton meters and 10 Newton meters.

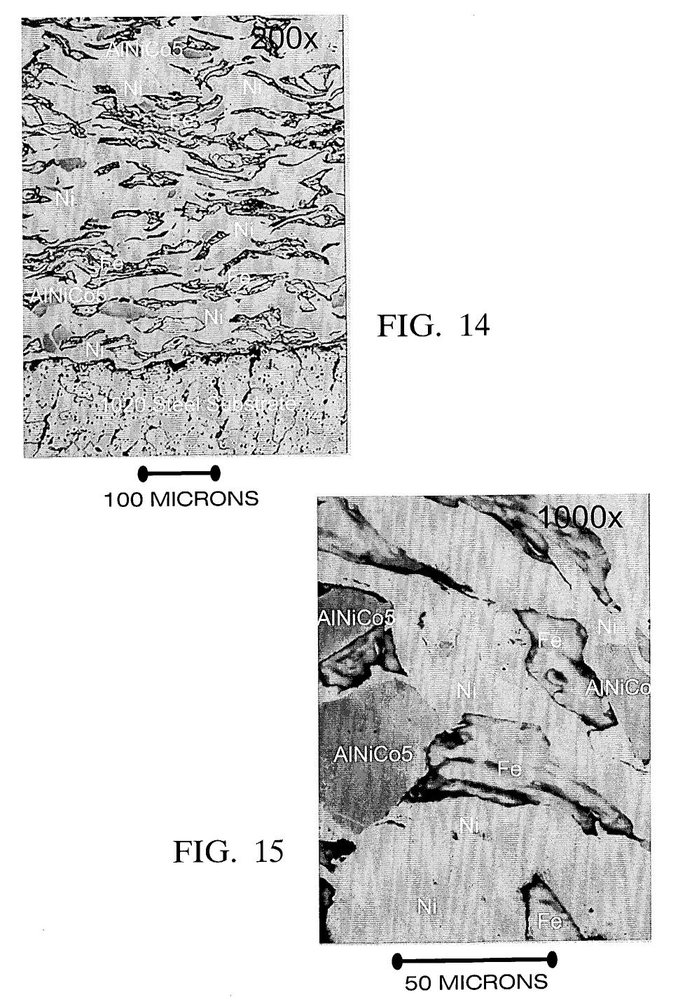

Referring now to FIGS. 14 and 15 photomicrographs of a magnetostrictive/magnetic composite of approximately 10 percent ALNiCo₅, 80 percent nickel and 10 percent iron (initial starting powder composition) is illustrated under 200× magnification and a 1000× magnification. FIGS. 14 and 15 clearly illustrate the dispersion of the iron or high coercivity material throughout the composite as it is applied through the kinetic spray application process.

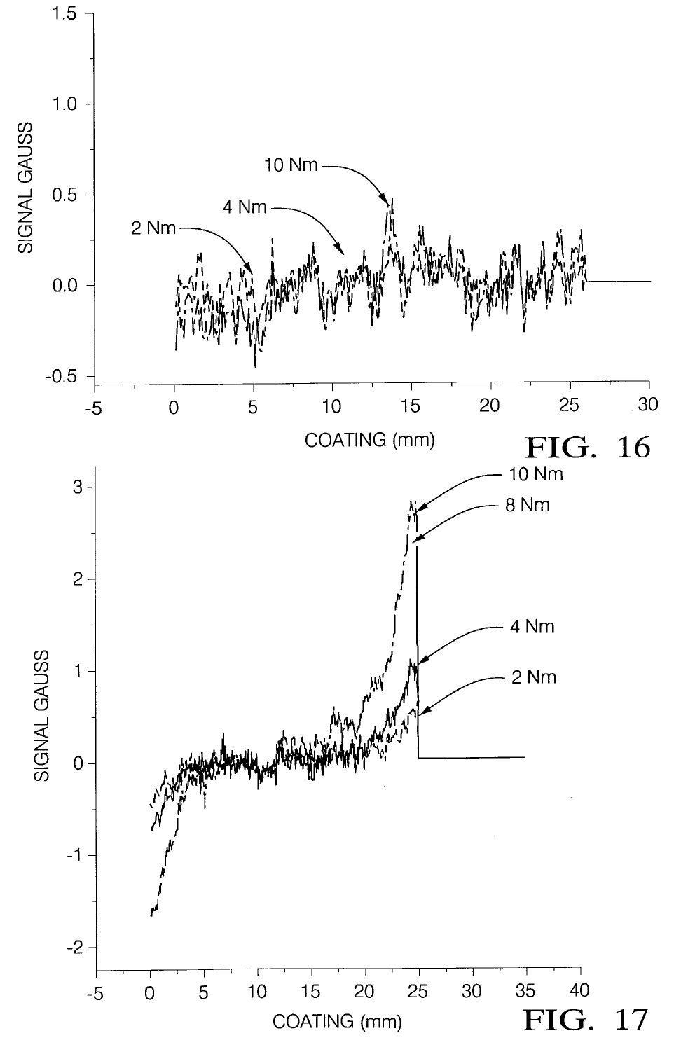

FIG. 16 is a graph illustrating the torque signal response of a kinetically sprayed magnetostrictive/magnetic composite coating of approximately 10 percent ALNiCo₅, 80 percent nickel and 10 percent iron C deposited on a 1020 steel shaft. The measured applied torques were 2 Newton meter's, 4 Newton meters and 10 Newton meters.

FIG. 17 is a graph illustrating the torque signal response as a function of applied torque of a kinetically sprayed magnetostrictive/magnetic composite coating of approximately 10 percent ALNiCo₅, 80 percent nickel and 10 percent iron (initial starting powder composition) deposited on a 6061-T6 Aluminum shaft. The measured applied torques were 2 Newton meters, 4 Newton meters, 8 Newton meters and 10 Newton meters.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A kinetically sprayed magnetostrictive/magnetic material, comprising:
magnetostrictive particles;
magnetic particles with coercivity;
a ductile matrix for bonding the magnetostriction particles and magnetic particles with coercivity together;
wherein an applied magnetic field will align the magnetic particles with coercivity and subsequently the magnetostrictive particles such that the magnetostrictive material will produce a detectable change in the magnetostrictive/magnetic material when placed under an applied stress.

2. The kinetically sprayed magnetostrictive/magnetic material as in claim 1, wherein said detectable change is an external magnetic flux.

3. The kinetically sprayed magnetostrictive/magnetic material as in claim 1, wherein either the magnetostriction particles or the magnetic particles with coercivity provides said ductile matrix.

4. The kinetically sprayed magnetostrictive/magnetic material as in claim 3, wherein the magnetostriction particles are one of the following: iron, iron alloys, ingot rare earth composites, nickel, terfenol and the magnetic particles with coercivity are AlNiCo₅ magnets or melt spun terfenol.

5. The kinetically sprayed magnetostrictive/magnetic material as in claim 1, wherein the magnetostriction particles are one of the following: iron, iron alloys, ingot rare earth composites, terfenol and the magnetic particles with coercivity are AlNiCo₅ magnets or melt spun terfenol.

6. The kinetically sprayed magnetostrictive/magnetic material as in claim 5, wherein the ductile matrix comprises Ni.

7. The kinetically sprayed magnetostrictive/magnetic material as in claim 1, wherein the magnetostriction particles are one of the following: iron, iron alloys, ingot rare earth composites, nickel, terfenol and the magnetic particles with coercivity are AlNiCo₅ magnets or melt spun terfenol, and the ductile matrix is nickel (Ni) each comprising approximately 33 percent of the sprayed material.

8. The kinetically sprayed magnetostrictive/magnetic material as in claim 7, wherein the ductile matrix is copper and the material is disposed on a nitronic steel shaft.

9. The kinetically sprayed magnetostrictive/magnetic material as in claim 7, wherein the material is disposed on a nitronic steel shaft.

10. The kinetically sprayed magnetostrictive/magnetic material as in claim 1, wherein the magnetostriction particles are one of the following: iron, iron alloys, ingot rare earth composites, nickel, terfenol and the magnetic particles with coercivity are AlNiCo₅ magnets or melt spun terfenol and the ductile matrix is nickel (Ni) each comprising approximately 10 percent magnetic particles with coercivity, 80 percent nickel and 40 percent magnetostriction particles.

11. The kinetically sprayed magnetostrictive/magnetic material as in claim 1, wherein the magnetostriction particles are one of the following: iron, iron alloys, ingot rare earth composites, nickel, terfenol and the magnetic particles with coercivity are AlNiCo₅ magnets or melt spun terfenol and the ductile matrix is nickel (Ni) and the amount of nickel is in a range of 10-90 percent by volume of the sprayed material.

12. A method of forming a composite coating of magnetostrictive/magnetic material on a substrate, comprising:
spraying a powder mixture of magnetostriction particles, magnetic particles with coercivity and a ductile matrix in a spray gas stream flowing at supersonic velocity against the substrate to form a composite coating wherein an applied magnetic field will align the magnetostriction particles such that the magnetostrictive material will produce a detectable change in the magnetostrictive/magnetic material when placed under an applied stress.

13. The method as in claim 12, wherein either the magnetostriction particles or the magnetic particles with coercivity provides said ductile matrix.

14. The method as in claim 12, wherein the magnetostriction particles are one of the following: iron, iron alloys, ingot rare earth composites, terfenol and the magnetic particles with coercivity are AlNiCo₅ magnets or melt spun terfenol.

15. A kinetically sprayed magnetostrictive/magnetic material adapted for use in a torque sensor, comprising:
magnetostrictive particles;
magnetic particles with coercivity;
a ductile matrix for bonding the magnetostriction particles and magnetic particles with coercivity together;
wherein the magnetostrictive/magnetic material is kinetically sprayed to a shaft and an applied magnetic field will align the magnetic particles with coercivity and subsequently the magnetostrictive particles such that the magnetostrictive material will produce a detectable change in the magnetostrictive/magnetic material when a torque is applied to the shaft.

16. The kinetically sprayed magnetostrictive/magnetic material as in claim 15, wherein said detectable change is an external magnetic flux.

17. The kinetically sprayed magnetostrictive/magnetic material as in claim 15, wherein either the magnetostriction particles or the magnetic particles with coercivity provides said ductile matrix.

18. The kinetically sprayed magnetostrictive/magnetic material as in claim 15, wherein the magnetostriction particles are one of the following: iron, iron alloys, ingot rare earth composites, nickel, terfenol and the magnetic particles with coercivity are AlNiCo₅ magnets or melt spun terfenol.

19. The kinetically sprayed magnetostrictive/magnetic material as in claim 18, wherein the ductile matrix comprises Ni.

20. The kinetically sprayed magnetostrictive/magnetic material as in claim 15, wherein the shaft is a nitronic steel shaft.

21. The kinetically sprayed magnetostrictive/magnetic material as in claim 20, wherein the magnetostriction particles are one of the following: iron, iron alloys, ingot rare earth composites, nickel, terfenol and the magnetic particles with coercivity are AlNiCo₅ magnets or melt spun terfenol and the ductile matrix is nickel (Ni) each comprising approximately 10 percent magnetic particles with coercivity, 80 percent nickel and 10 percent magnetostriction particles.
